(19) United States
(12) Patent Application Publication
(10) Pub. No.: US 2022/0048730 A1
(43) Pub. Date: Feb. 17, 2022

(54) ELEVATOR CAR MOVER PROVIDING INTELLIGENT CONTROL BASED ON BATTERY STATE OF CHARGE

(71) Applicant: Otis Elevator Company, Farmington, CT (US)

(72) Inventor: Randy Roberts, Hebron, CT (US)

(21) Appl. No.: 16/995,047

(22) Filed: Aug. 17, 2020

(51) Int. Cl. B66B 1/30; B66B 9/02; B66B 11/04; B66B 1/34; B66B 5/02; B66B 1/24

(52) U.S. Cl. CPC B66B 1/302; B66B 9/02; B66B 11/043; B66B 2201/242; B66B 5/02; B66B 1/2433; B66B 2201/216; B66B 1/3492

(57) ABSTRACT

Disclosed is a car mover, configured to move an elevator car in lane of a hoistway, having: a power supply configured to power one or more motors to drive a respective one or more wheels; a car mover controller operationally connected to the power supply and a supervisory controller operationally connected to the car mover controller, wherein the car mover controller and the supervisory controller are configured to execute health monitor protocols to thereby: monitor a state of charge (SOC) of the power supply; and control the car mover in response to determining that the power supply is in a low SOC.

### BACKGROUND

Embodiments described herein relate to a multi-car elevator system and more specifically to an elevator car mover providing intelligent control based on a state of electrical charge storage.

An autonomous elevator car mover may use motor-driven wheels to propel the elevator car up and down on vertical track beams, which may be I-beams, having respective webs that form front and back track surfaces. Two elements to this system include the elevator car which will be guided by rollers guides on traditional T-rails, and the autonomous car mover which will house two (2) to four (4) motor-driven wheels. An operational goal of the car mover is to operate without delay due to depleted power.

### BRIEF SUMMARY

Disclosed is a car mover, configured to move an elevator car in lane of a hoistway, including: a power supply configured to power one or more motors to drive a respective one or more wheels; a car mover controller operationally connected to the power supply and a supervisory controller operationally connected to the car mover controller, wherein the car mover controller and the supervisory controller are configured to execute health monitor protocols to thereby: monitor a state of charge (SOC) of the power supply; and control the car mover in response to determining that the power supply is in a low SOC.

In addition to one or more of the above aspects of the car mover, or as an alternate, when executing the health monitor protocols, the car mover controller is configured to execute a vehicle control module, to thereby execute a plurality of levels of vehicle control in response to determining that the power supply is in a low SOC, including: a first level of vehicle control, including adjusting one or more motion control parameters of the car mover.

In addition to one or more of the above aspects of the car mover, or as an alternate, the one or more motion control parameters of the car mover includes a velocity of the car mover.

In addition to one or more of the above aspects of the car mover, or as an alternate, a second level of vehicle control includes directing the car mover to park at a nearest floor.

In addition to one or more of the above aspects of the car mover, or as an alternate, when executing the vehicle control module, the car mover controller is configured to monitor the SOC of the power supply and one or more of: a position of the car mover in the hoistway; a velocity of the car mover; an acceleration of the car mover; vibrations and impulses experienced by the car mover; and a load of the car mover.

In addition to one or more of the above aspects of the car mover, or as an alternate, the car mover controller is configured to execute the vehicle control module upon determining that the SOC of the power supply is: below a first stored power range to execute proactive power management of the power supply; and within a second stored power range to execute reactive power management of the power supply.

In addition to one or more of the above aspects of the car mover, or as an alternate, when executing the health monitor protocols, the supervisory controller is configured to execute a supervisory control module, to thereby execute a plurality of levels of supervisory control in response to determining that the power supply is in a low SOC, including: a first level of supervisory control, including adjusting dispatching requirements of the elevator car operationally connected to the car mover.

In addition to one or more of the above aspects of the car mover, or as an alternate, a second level of supervisory control includes directing the car mover to a charging station.

In addition to one or more of the above aspects of the car mover, or as an alternate, when executing the vehicle control module, the supervisory controller is configured to monitor the SOC of the power supply, and one or more of: a position of other car movers within the hoistway; requested floors to serve; and a location of charging stations in the hoistway.

In addition to one or more of the above aspects of the car mover, or as an alternate, the supervisory controller is configured to execute the supervisory control module upon determining that the SOC of the power supply is: within a first stored power range to execute proactive power management of the power supply; and above a second stored power range to execute reactive power management of the power supply.

Further disclosed is a method of operating a car mover, configured to move an elevator car in lane of a hoistway, including: powering, with a power supply, one or more motors, to drive a respective one or more wheels of the car mover, wherein a car mover controller is operationally connected to the power supply and a supervisory controller operationally connected to the car mover controller; executing health monitor protocols by the car mover controller and the supervisory controller, including: monitoring a state of charge (SOC) of the power supply; and controlling the car mover in response to determining that the power supply is in a low SOC.

In addition to one or more of the above aspects of the method, or as an alternate, the method includes executing a vehicle control module, by the car mover controller when executing the health monitor protocols, thereby executing a plurality of levels of vehicle control in response to determining that the power supply is in a low SOC, including: executing a first level of vehicle control, including adjusting one or more motion control parameters of the car mover.

In addition to one or more of the above aspects of the method, or as an alternate, the one or more motion control parameters of the car mover includes velocity, acceleration, of the car mover, and vibrations and impulses experienced by the car mover.

In addition to one or more of the above aspects of the method, or as an alternate, the method includes executing a second level of vehicle control, including directing the car mover to park at a nearest floor.

In addition to one or more of the above aspects of the method, or as an alternate, the method includes monitoring, by the car mover controller when executing the vehicle control module, the SOC of the power supply and one or more of: a position of the car mover in the hoistway; a velocity of the car mover; an acceleration of the car mover; vibrations and impulses experienced by the car mover; and a load of the car mover.

In addition to one or more of the above aspects of the method, or as an alternate, the method includes executing the vehicle control module by the car mover controller upon determining that the SOC of the power supply is: below a first stored power range to execute proactive power management of the power supply; and within a second stored power range to execute reactive power management of the power supply.

In addition to one or more of the above aspects of the method, or as an alternate, the method includes executing a supervisory control module by the supervisory controller when executing the health monitor protocols, thereby executing a plurality of levels of supervisory control in response to determining that the power supply is in a low SOC, including: executing a first level of supervisory control, including adjusting dispatching requirements of the elevator car operationally connected to the car mover.

In addition to one or more of the above aspects of the method, or as an alternate, the method includes executing a second level of supervisory control, including directing the car mover to a charging station.

In addition to one or more of the above aspects of the method, or as an alternate, the method includes monitoring, by the supervisory controller when executing the vehicle control module, the SOC of the power supply, and one or more of: a position of other car movers within the hoistway; requested floors to serve; and a location of charging stations in the hoistway.

In addition to one or more of the above aspects of the method, or as an alternate, the method includes executing the supervisory control module by the supervisory controller upon determining that the SOC of the power supply is: within a first stored power range to execute proactive power management of the power supply; and above a second stored power range to execute reactive power management of the power supply.

### BRIEF DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 is a schematic of elevator cars and car movers in a hoistway lane according to an embodiment;

FIG. 2 shows a car mover according to an embodiment;

FIG. 3 is a process diagram for executing health monitor protocols related to the state of charge for a power supply according to an embodiment; and

FIGS. 4A-4B show a flowchart of a method of executing health monitor protocols related to the state of charge for a power supply according to an embodiment.

### DETAILED DESCRIPTION

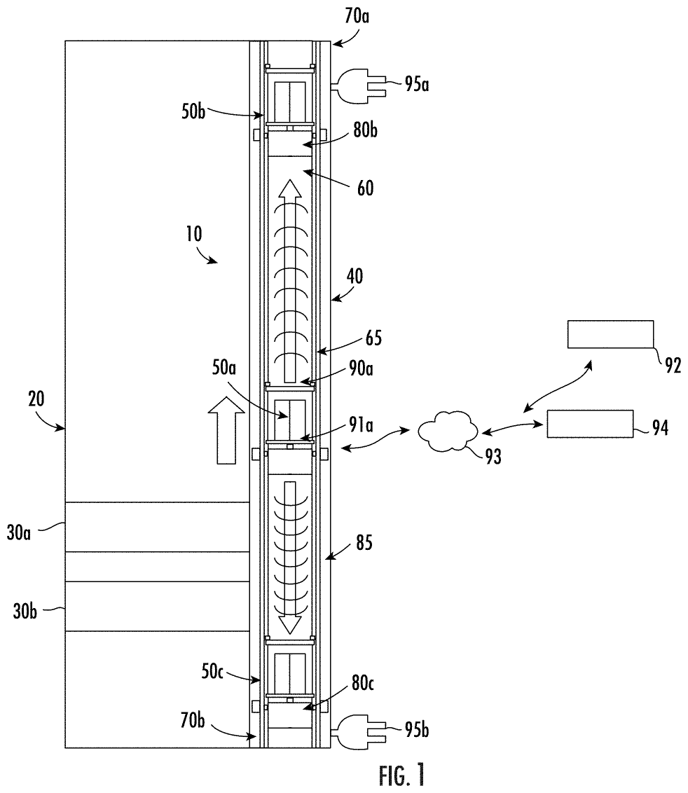

FIG. 1 depicts a self-propelled or ropeless elevator system (elevator system) 10 in an exemplary embodiment that may be used in a structure or building 20 having multiple levels or floors 30a, 30b. Elevator system 10 includes a hoistway 40 (or elevator shaft) defined by boundaries carried by the building 20, and a plurality of cars 50a-50c adapted to travel in a hoistway lane 60 along an elevator car track 65 (which may be a T-rail) in any number of travel directions (e.g., up and down). The cars 50a-50c are generally the same so that reference herein shall be to the elevator car 50a. The hoistway 40 may also include a top end terminus 70a and a bottom end terminus 70b.

For each of the cars 50a-50c, the elevator system 10 includes one of a plurality of car mover systems (car movers) 80a-80c (otherwise referred to as a beam climber system, or beam climber, for reasons explained below). The car movers 80a-80c are generally the same so that reference herein shall be to the car 50a. The car mover 80a is configured to move along a car mover track 85 (or track beam 85, which may be an I-beam) to move the elevator car 50a along the hoistway lane 60, and to operate autonomously. The car mover 80a may be positioned to engage the top 90a of the car 50a, the bottom 91a of the car 50a, or any desired location(s) on the car 50a. In FIG. 1, the car mover 80a engages the bottom 91a of the car 50a.

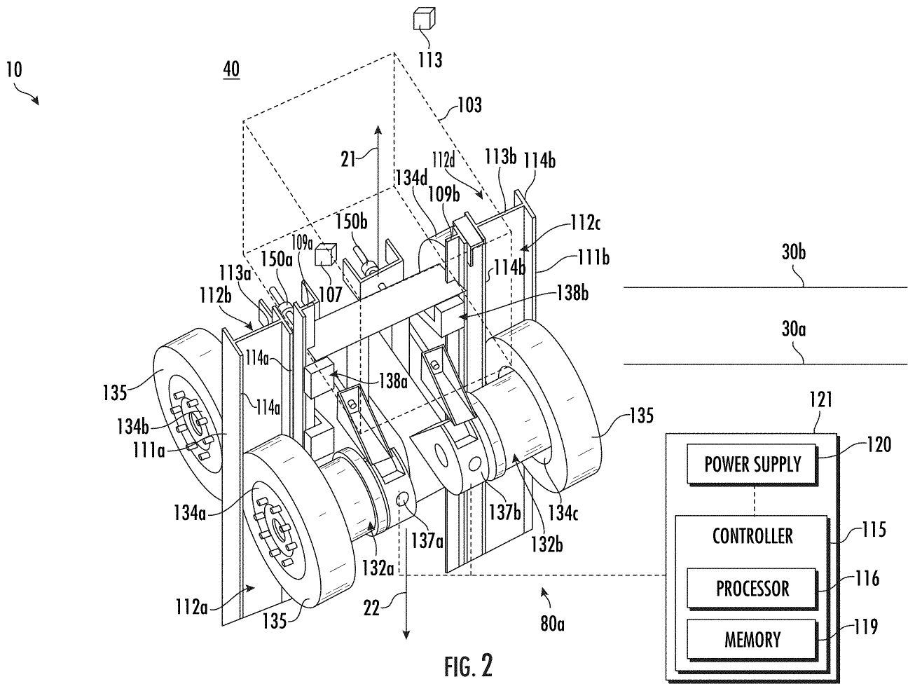

Though the car mover 80a operates autonomously, a supervisory hub 92 (also referred to as a supervisory controller) for the elevator system 10 may be included that may be configured with sufficient processors, discussed below, for communicating with the car mover 80a to provide a certain level of supervisory instructions, communicate notifications, alerts, relay information bidirectionally, etc. The supervisory controller 92 may communicate using wireless or wired transmission paths as identified below. Transmission channels may be direct or via a network 93, and may include a cloud service 94, as further discussed below. The hoistway may have charging stations 95a, 95b for charging a power supply 120 (FIG. 2, discussed below) on board the car mover 80a.

FIG. 2 is a perspective view of an elevator system 10 including the elevator car 50a, a car mover 80a, a controller 115, and a power source 120. Although illustrated in FIG. 1 as separate from the car mover 80a, the embodiments described herein may be applicable to a controller 115 included in the car mover 80a (i.e., moving through an hoistway 40 with the car mover 80a) and may also be applicable to a controller located off of the car mover 80a (i.e., remotely connected to the car mover 80a and stationary relative to the car mover 80a).

Although illustrated in FIG. 1 as separate from the car mover 80a, the embodiments described herein may be applicable to a power source 120 included in the car mover 80a (i.e., moving through the hoistway 40 with the car mover 80a) and may also be applicable to a power source located off of the car mover 80a (i.e., remotely connected to the car mover 80a and stationary relative to the car mover 80a).

The car mover 80a is configured to move the elevator car 50a within the hoistway 40 and along guide rails 109a, 109b that extend vertically through the hoistway 40. In an embodiment, the guide rails 109a, 109b are T-beams. The car mover 80a includes one or more electric motors 132a, 132b. The electric motors 132a, 132b are configured to move the car mover 80a within the hoistway 40 by rotating one or more motorized wheels 134a, 134b that are pressed against a guide beam 111a, 111b that form the car mover track 85 (FIG. 1). In an embodiment, the guide beams 111a, 111b are I-beams. It is understood that while an I-beam is illustrated any beam or similar structure may be utilized with the embodiment described herein. Friction between the wheels 134a, 134b, 134c, 134d driven by the electric motors 132a, 132b allows the wheels 134a, 134b, 134c, 134d climb up 21 and down 22 the guide beams 111a, 111b. The guide beam extends vertically through the hoistway 40. It is understood that while two guide beams 111a, 111b are illustrated, the embodiments disclosed herein may be utilized with one or more guide beams. It is also understood that while two electric motors 132a, 132b are illustrated, the embodiments disclosed herein may be applicable to car movers 80a having one or more electric motors. For example, the car mover 80a may have one electric motor for each of the four wheels 134a, 134b, 134c, 134d (generically wheels 134). The electrical motors 132a, 132b may be permanent magnet electrical motors, asynchronous motor, or any electrical motor known to one of skill in the art. In other embodiments, not illustrated herein, another configuration could have the powered wheels at two different vertical locations (i.e., at bottom and top of an elevator car 50a).

The first guide beam 111a includes a web portion 113a and two flange portions 114a. The web portion 113a of the first guide beam 111a includes a first surface 112a and a second surface 112b opposite the first surface 112a. A first wheel 134a is in contact with the first surface 112a and a second wheel 134b is in contact with the second surface 112b. The first wheel 134a may be in contact with the first surface 112a through a tire 135 and the second wheel 134b may be in contact with the second surface 112b through a tire 135. The first wheel 134a is compressed against the first surface 112a of the first guide beam 111a by a first compression mechanism 150a and the second wheel 134b is compressed against the second surface 112b of the first guide beam 111a by the first compression mechanism 150a. The first compression mechanism 150a compresses the first wheel 134a and the second wheel 134b together to clamp onto the web portion 113a of the first guide beam 111a.

The first compression mechanism 150a may be a metallic or elastomeric spring mechanism, a pneumatic mechanism, a hydraulic mechanism, a turnbuckle mechanism, an electromechanical actuator mechanism, a spring system, a hydraulic cylinder, a motorized spring setup, or any other known force actuation method.

The first compression mechanism 150a may be adjustable in real-time during operation of the elevator system 10 to control compression of the first wheel 134a and the second wheel 134b on the first guide beam 111a. The first wheel 134a and the second wheel 134b may each include a tire 135 to increase traction with the first guide beam 111a.

The first surface 112a and the second surface 112b extend vertically through the hoistway 40, thus creating a track surface for the first wheel 134a and the second wheel 134b to ride on. The flange portions 114a may work as guardrails to help guide the wheels 134a, 134b along this track surface and thus help prevent the wheels 134a, 134b from running off track surface.

The first electric motor 132a is configured to rotate the first wheel 134a to climb up 21 or down 22 the first guide beam 111a. The first electric motor 132a may also include a first motor brake 137a to slow and stop rotation of the first electric motor 132a.

The first motor brake 137a may be mechanically connected to the first electric motor 132a. The first motor brake 137a may be a clutch system, a disc brake system, a drum brake system, a brake on a rotor of the first electric motor 132a, an electronic braking, an Eddy current brakes, a Magnetorheological fluid brake or any other known braking system. The beam climber system 130 may also include a first guide rail brake 138a operably connected to the first guide rail 109a. The first guide rail brake 138a is configured to slow movement of the beam climber system 130 by clamping onto the first guide rail 109a. The first guide rail brake 138a may be a caliper brake acting on the first guide rail 109a on the beam climber system 130, or caliper brakes acting on the first guide rail 109 proximate the elevator car 50a.

The second guide beam 111b includes a web portion 113b and two flange portions 114b. The web portion 113b of the second guide beam 111b includes a first surface 112c and a second surface 112d opposite the first surface 112c. A third wheel 134c is in contact with the first surface 112c and a fourth wheel 134d is in contact with the second surface 112d. The third wheel 134c may be in contact with the first surface 112c through a tire 135 and the fourth wheel 134d may be in contact with the second surface 112d through a tire 135. A third wheel 134c is compressed against the first surface 112c of the second guide beam 111b by a second compression mechanism 150b and a fourth wheel 134d is compressed against the second surface 112d of the second guide beam 111b by the second compression mechanism 150b. The second compression mechanism 150b compresses the third wheel 134c and the fourth wheel 134d together to clamp onto the web portion 113b of the second guide beam 111b.

The second compression mechanism 150b may be a spring mechanism, turnbuckle mechanism, an actuator mechanism, a spring system, a hydraulic cylinder, and/or a motorized spring setup. The second compression mechanism 150b may be adjustable in real-time during operation of the elevator system 10 to control compression of the third wheel 134c and the fourth wheel 134d on the second guide beam 111b. The third wheel 134c and the fourth wheel 134d may each include a tire 135 to increase traction with the second guide beam 111b.

The first surface 112c and the second surface 112d extend vertically through the shaft 117, thus creating a track surface for the third wheel 134c and the fourth wheel 134d to ride on. The flange portions 114b may work as guardrails to help guide the wheels 134c, 134d along this track surface and thus help prevent the wheels 134c, 134d from running off track surface.

The second electric motor 132b is configured to rotate the third wheel 134c to climb up 21 or down 22 the second guide beam 111b. The second electric motor 132b may also include a second motor brake 137b to slow and stop rotation of the second motor 132b. The second motor brake 137b may be mechanically connected to the second motor 132b. The second motor brake 137b may be a clutch system, a disc brake system, drum brake system, a brake on a rotor of the second electric motor 132b, an electronic braking, an Eddy current brake, a Magnetorheological fluid brake, or any other known braking system. The beam climber system 130 includes a second guide rail brake 138b operably connected to the second guide rail 109b. The second guide rail brake 138b is configured to slow movement of the beam climber system 130 by clamping onto the second guide rail 109b. The second guide rail brake 138b may be a caliper brake acting on the first guide rail 109a on the beam climber system 130, or caliper brakes acting on the first guide rail 109a proximate the elevator car 50a.

The elevator system 10 may also include a position reference system (PRS) 113. The position reference system 113 may be mounted on a fixed part at the top of the hoistway 40, such as on a support or guide rail 109, and may be configured to provide position signals related to a position of the elevator car 50a within the hoistway 40. In other embodiments, the position reference system 113 may be directly mounted to a moving component of the elevator system (e.g., the elevator car 50a or the car mover 80a), or may be located in other positions and/or configurations.

The position reference system 113 can be any device or mechanism for monitoring a position of an elevator car within the elevator shaft 117. For example, without limitation, the position reference system 113 can be an encoder, sensor, accelerometer, altimeter, pressure sensor, range finder, or other system and can include velocity sensing, absolute position sensing, etc., as will be appreciated by those of skill in the art.

The controller 115 may be an electronic controller including a processor 116 and an associated memory 119 comprising computer-executable instructions that, when executed by the processor 116, cause the processor 116 to perform various operations. The processor 116 may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory 119 may be but is not limited to a random access memory (RAM), read only memory (ROM), or other electronic, optical, magnetic or any other computer readable medium.

The controller 115 is configured to control the operation of the elevator car 50a and the car mover 80a. For example, the controller 115 may provide drive signals to the car mover 80a to control the acceleration, deceleration, leveling, stopping, etc. of the elevator car 50a.

The controller 115 may also be configured to receive position signals from the position reference system 113 or any other desired position reference device. The data transmitted between the controller 115 and position reference system 113 may be obtained and processed separately and stitched together, or processed at one of the two components, and may be processed in a raw or complied form.

When moving up 21 or down 22 within the hoistway 40 along the guide rails 109a, 109b, the elevator car 50a may stop at one or more floors 30a, 30b as controlled by the controller 115. In one embodiment, the controller 115 may be located remotely or in the cloud. In another embodiment, the controller 115 may be located on the car mover 80a

The power supply 120 for the elevator system 10 may be any power source, including a power grid and/or battery power which, in combination with other components, is supplied to the car mover 80a. In one embodiment, power source 120 may be located on the car mover 80a. In an embodiment, the power supply 120 is a battery that is included in the car mover 80a. The elevator system 10 may also include an accelerometer 107 attached to the elevator car 50a or the car mover 80a. The accelerometer 107 is configured to detect an acceleration and/or a speed of the elevator car 50a and the car mover 80a.

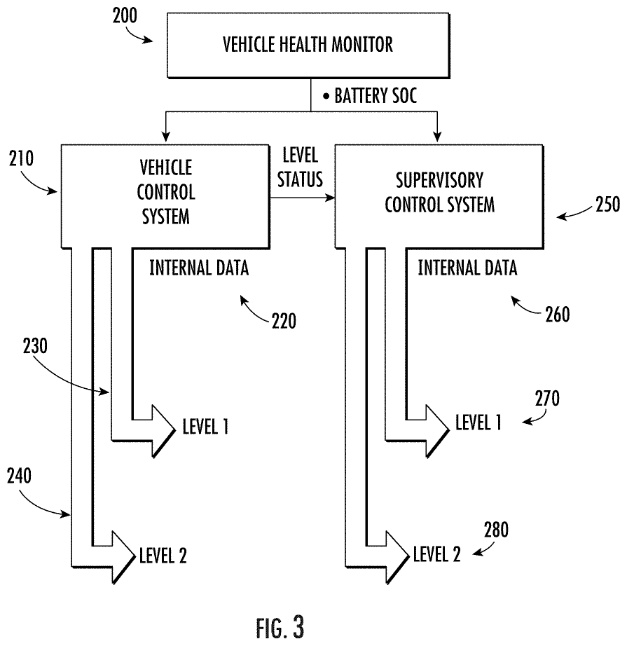

Turning now to FIG. 3, the disclosed car mover 80a, functioning as a beam climber in the elevator system 10, may allow for multiple cars 50a, 50b to be operational in a single hoistway (lane) 60 and with the use of horizontal transfer stations (not shown) in a set of vertical (up and down) lanes, e.g., including lane 60, in a recirculation configuration. In the system 10, the car movers e.g., movers 80a, 80b may not need to have a hardwired connection to the hoistway 40 and may instead have a power supply 120. The power supply 120 may include an on-board battery pack, capacitors, or other power storage implement such as other types of fuel cells or pneumatic or hydraulic systems where operational materials, including but not limited to fluids and/or gasses, may require monitoring, replenishing and/or recharging. The power supply 120 may require be periodic charging to maintain operation. Thus the state-of-charge (SOC) of the power supply 120 may need to be monitored and controlled to maximize performance.

As shown in the FIG. 3 the elevator system 10 is configured to execute vehicle heath monitor protocols (or health monitor protocols) 200. Executing the health monitor protocols 200 includes executing a vehicle control module 210 (which may be referred to as on-vehicle SOC reactive control), which may be software for executing the respective set of protocols on board the car mover controller 115. Alternatively the vehicle control module 210 includes computing hardware similar to the car mover controller 115 and in communication with the car mover controller 115 onboard the car mover 80a. Executing the health monitor protocols 200 also includes executing a supervisory control module 250, which may be software on board the supervisory controller 92 or computing hardware similar to the car mover controller 115 on board the supervisory controller 92, on a cloud service 94, or in another computing environment in communication with the car mover controller 115. For this communication, the supervisory controller 92 receives data from the car mover controller 115 responsive to execution of the vehicle control module 210. Execution of the health monitor protocols 200 optimizes the control of the car mover 80a. In one embodiment, the supervisory control module 250 is executed on the car mover controller 115 (or another processor on board the car mover 80a that is operationally connected to the car mover controller 115) and one or more resulting commands from this execution are sent to the supervisory controller 92.

The car mover controller 115, executing the vehicle control module 210, is configured to utilize data from the sensor 113, referenced in FIG. 3 as internal data 220, to determine the SOC of the power supply 120. Based on the SOC of the power supply 120, the car mover controller 115 is configured to execute two levels of response to the SOC of the power supply 120, including a first level (level 1) 230 response and a second level (level 2) 240 response. The sensor data considered by the car mover controller 115 includes a current car position, sensed velocity, sensed acceleration, expected and unexpected movements and vibrations, and a load in the car.

As a first level 230 of response the car mover controller 115 includes adjusting motion control parameters of the car mover to accommodate a low sensed SOC. As a second level 240 of response, the car mover controller 115 instructs the car mover 80a to travel to a nearest floor and terminate a current run. In one embodiment, providing there is enough power (such as within a low, non-critical range, e.g., 10-25% of a maximum SOC), the car mover 80a may travel to a nearest floor to drop off passengers and then travel to a charging station if that is located at a different floor. In one embodiment, a level of power may determine which direction the car mover 80a travels. For example, if power is very low (within a critical range, such as between 5-10% of a maximum SOC), the car mover 80a may preferentially travel in a downward direction to drop off remaining passengers and/or reach a charging station being that traveling downward may require the utilization of less power. Below a critical threshold range, e.g., below 5% of maximum SOC, the car mover 80a may be in a power-drained range and may be required to notify maintenance and travel to a nearest lower charging station and remain there to undergo a maintenance inspection. These responses by the car mover controller 115 may be considered reactive responses, which respond to different levels of a low sensed SOC to avoid a loss of power during a current run. Another level of response may include applying brakes when moving in a downward direction, when equipped with a regenerative braking system, to charge the power system.

The supervisory controller 92, executing the supervisory control module 250, is also configured to utilize internal data 260 when determining which of two levels of response to apply, including a first level (level 1) 270 response and a second level (level 2) 280 response. The internal data 260 considered by the supervisory controller 92 include a position of all cars 50a, 50b, in a hoistway 40, requested floors to serve by the cars, e.g., cars 50a, 50b, and a location of the charging stations 95a, 95b relative the cars 50a, 50b in service.

As a first level 270 of response, the supervisory controller 92 may adjust dispatching requirements. For example, if the SOC of the power supply 120 of the car mover 80a is low (such as within or below the low, non-critical range) and another car mover 80b with another elevator car 50b with a higher SOC is available, that other car mover 80a may be dispatched. As a second level 280 of response the supervisory controller 92 may direct the car mover 80a to a charging station 95a, 95b. Both responses by the supervisory controller 92 may be considered proactive responses, which are responsive to different levels of a low SOC for the power supply 120, to ensure that the power levels remain sufficiently high during required runs.

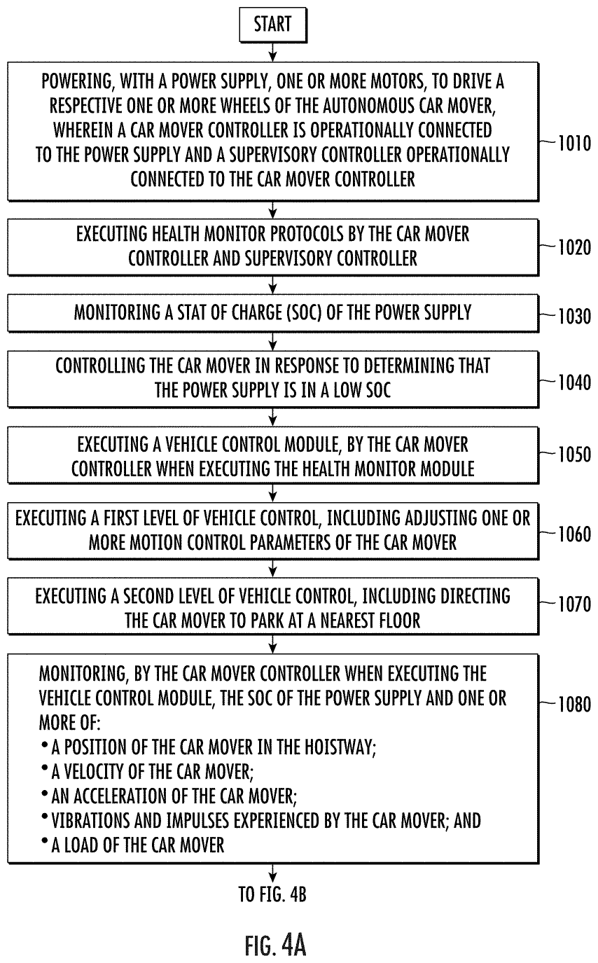

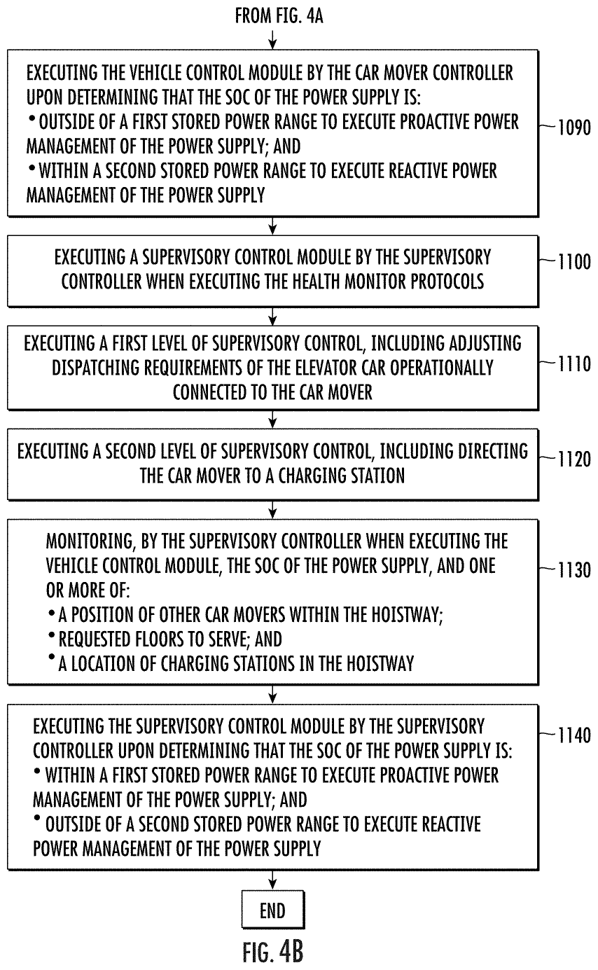

Turning to FIGS. 4A-4B a flowchart shows a method of operating a car mover 80a, configured to autonomously move an elevator car 50a in lane 60 of a hoistway 40. As shown in block 1010, the method includes powering, with a power supply 120, one or more motors, e.g., motor 132a (FIG. 2), to drive a respective one or more wheels, e.g., wheel 134a of the autonomous car mover 80a. A car mover controller 115 is operationally connected to the power supply 120 and a supervisory controller 92 is operationally connected to the car mover controller 115.

As shown in block 1020, the method includes executing health monitor protocols by the car mover controller 115 and supervisory controller 92. For example, as shown in block 1030, the method includes monitoring a state of charge (SOC) of the power supply 120. As shown in block 1040, the method includes controlling the car mover 80a in response to determining that the power supply is in a low SOC, e.g., as indicated above, within the low, non-critical range, the critical range, or the power-drained range.

As shown in block 1050, the method includes executing a vehicle control module 210, by the car mover controller 115 when executing the health monitor protocols 200. From this operation, the car mover controller 115 executes a plurality of levels of vehicle control in response to determining that the power supply 120 is in a low SOC.

As shown in block 1060, the method includes executing a first level 230 of vehicle control, including adjusting one or more motion control parameters of the car mover 80a. In one embodiment, as indicated the one or more motion control parameters of the car mover 80a includes velocity, acceleration, of the car mover 80a, and vibrations and impulses experienced by the car mover 80a. As shown in block 1070, the method includes executing a second level 240 of vehicle control, including directing the car mover 80a to park at a nearest floor. Alternatively, a deceleration rate or brake activation may be altered to allow the car mover 80a to stop at the nearest floor.

As shown in block 1080, the method includes monitoring, by the car mover controller 115 when executing the vehicle control module 210, the SOC of the power supply 120 and additional parameters. The additional parameters include one or more of a position of the car mover 80a in the hoistway 40, a velocity of the car mover 80a, an acceleration of the car mover 80a, vibrations and impulses experienced by the car mover 80a, and a load of the car mover 80a.

As shown in block 1090, the method includes executing the vehicle control module 210 by the car mover controller 115 upon determining that the SOC of the power supply 120 is within a predetermined range. The predetermined range is below a first stored power range to execute proactive power management of the power supply 120, and within a second stored power range to execute reactive power management of the power supply 120. This is determined by the supervisory controller 92 and the car mover controller 115 exchanging information based on execution of their respective protocols.

As shown in block 1100, the method includes executing a supervisory control module 250 by the supervisory controller 92 when executing the health monitor protocols 200. From this operation, the supervisory controller 92 executes a plurality of levels of supervisory control in response to determining that the power supply 120 is in a low SOC. As shown in block 1110, the method includes executing a first level 270 of supervisory control, including adjusting dispatching requirements of the elevator car 50a operationally connected to the car mover 80a. As shown in block 1120, the method includes executing a second level 280 of supervisory control, including directing the car mover 80a to a charging station 95a, 95b.

As shown in block 1130, the method includes monitoring, by the supervisory controller 92 when executing the vehicle control module 210, the SOC of the power supply 120, and one or more additional parameters. The one or more additional parameters include a position of other car movers 80b within the hoistway 40, requested floors to serve, and a location of charging stations 95a, 95b in the hoistway 40. As shown in block 1140, the method includes executing the supervisory control module 250 by the supervisory controller 92 upon determining that the SOC of the power supply 120 is with a predetermined range. The predetermined range is within a first stored power range to execute proactive power management of the power supply 120, and within a second stored power range to execute reactive power management of the power supply 120. For example, the first stored range may be above or partially overlapping the low, non-critical range. The second stored range may be any of the low, non-critical range, the critical range, or the power-drained range. This is determined by the supervisory controller 92 and the car mover controller 115 exchanging information based on execution of their respective protocols.

The above disclosed health monitor protocols 200 may optimize performance of battery-powered car mover 80a, providing optimized reactive and proactive accommodations via the car mover controller 115 and supervisory controller 92 executing the vehicle control module 210 and supervisory control module 250. This disclosed system may maximize elevator performance while also minimizing the impact of required charging downtimes.

Wireless connections identified above may apply protocols that include local area network (LAN, or WLAN for wireless LAN) protocols and/or a private area network (PAN) protocols. LAN protocols include WiFi technology, based on the Section 802.11 standards from the Institute of Electrical and Electronics Engineers (IEEE). PAN protocols include, for example, Bluetooth Low Energy (BTLE), which is a wireless technology standard designed and marketed by the Bluetooth Special Interest Group (SIG) for exchanging data over short distances using short-wavelength radio waves. PAN protocols also include Zigbee, a technology based on Section 802.15.4 protocols from the IEEE, representing a suite of high-level communication protocols used to create personal area networks with small, low-power digital radios for low-power low-bandwidth needs. Such protocols also include Z-Wave, which is a wireless communications protocol supported by the Z-Wave Alliance that uses a mesh network, applying low-energy radio waves to communicate between devices such as appliances, allowing for wireless control of the same.

Other applicable protocols include Low Power WAN (LPWAN), which is a wireless wide area network (WAN) designed to allow long-range communications at a low bit rates, to enable end devices to operate for extended periods of time (years) using battery power. Long Range WAN (LoRaWAN) is one type of LPWAN maintained by the LoRa Alliance, and is a media access control (MAC) layer protocol for transferring management and application messages between a network server and application server, respectively. Such wireless connections may also include radio-frequency identification (RFID) technology, used for communicating with an integrated chip (IC), e.g., on an RFID smartcard. In addition, Sub-1Ghz RF equipment operates in the ISM (industrial, scientific and medical) spectrum bands below Sub 1 Ghz—typically in the 769-935 MHz, 315 Mhz and the 468 Mhz frequency range. This spectrum band below 1 Ghz is particularly useful for RF IOT (internet of things) applications. Other LPWAN-IOT technologies include narrowband internet of things (NB-IOT) and Category M1 internet of things (Cat M1-IOT). Wireless communications for the disclosed systems may include cellular, e.g. 2G/3G/4G (etc.). The above is not intended on limiting the scope of applicable wireless technologies.

Wired connections identified above may include connections (cables/interfaces) under RS (recommended standard)-422, also known as the TIA/EIA-422, which is a technical standard supported by the Telecommunications Industry Association (TIA) and which originated by the Electronic Industries Alliance (EIA) that specifies electrical characteristics of a digital signaling circuit. Wired connections may also include (cables/interfaces) under the RS-232 standard for serial communication transmission of data, which formally defines signals connecting between a DTE (data terminal equipment) such as a computer terminal, and a DCE (data circuit-terminating equipment or data communication equipment), such as a modem. Wired connections may also include connections (cables/interfaces) under the Modbus serial communications protocol, managed by the Modbus Organization. Modbus is a master/slave protocol designed for use with its programmable logic controllers (PLCs) and which is a commonly available means of connecting industrial electronic devices. Wireless connections may also include connectors (cables/interfaces) under the PROFibus (Process Field Bus) standard managed by PROFIBUS & PROFINET International (PI). PROFibus which is a standard for fieldbus communication in automation technology, openly published as part of IEC (International Electrotechnical Commission) 61158. Wired communications may also be over a Controller Area Network (CAN) bus. A CAN is a vehicle bus standard that allow microcontrollers and devices to communicate with each other in applications without a host computer. CAN is a message-based protocol released by the International Organization for Standards (ISO). The above is not intended on limiting the scope of applicable wired technologies.

As indicated, each processor identified herein may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory identified herein may be but is not limited to a random access memory (RAM), read only memory (ROM), or other electronic, optical, magnetic or any other computer readable medium. As also described above, embodiments can be in the form of processor-implemented processes and devices for practicing those processes, such as processor. Embodiments can also be in the form of computer program code (e.g., computer program product) containing instructions embodied in tangible media (e.g., non-transitory computer readable medium), such as floppy diskettes, CD ROMs, hard drives, or any other non-transitory computer readable medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an device for practicing the exemplary embodiments. When implemented on a general-purpose microprocessor, the computer program code segments configure the microprocessor to create specific logic circuits.

The terminology used herein is for the purpose of describing particular embodiments only and is not intended to be limiting of the present disclosure. The term “about” is intended to include the degree of error associated with measurement of the particular quantity and/or manufacturing tolerances based upon the equipment available at the time of filing the application. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

what is claimed is:

1. A car mover, configured to move an elevator car in lane of a hoistway, comprising:
a power supply configured to power one or more motors to drive a respective one or more wheels;
a car mover controller operationally connected to the power supply and a supervisory controller operationally connected to the car mover controller,
wherein the car mover controller and the supervisory controller are configured to execute health monitor protocols to thereby:
monitor a state of charge (SOC) of the power supply; and
control the car mover in response to determining that the power supply is in a low SOC.

2. The car mover of claim 1, wherein:
when executing the health monitor protocols, the car mover controller is configured to execute a vehicle control module, to thereby execute a plurality of levels of vehicle control in response to determining that the power supply is in a low SOC, including:
a first level of vehicle control, including adjusting one or more motion control parameters of the car mover.

3. The car mover of claim 2, wherein:
the one or more motion control parameters of the car mover includes a velocity of the car mover.

4. The car mover of claim 2, wherein:
a second level of vehicle control includes directing the car mover to park at a nearest floor.

5. The car mover of claim 4, wherein:
when executing the vehicle control module, the car mover controller is configured to monitor the SOC of the power supply and one or more of:
a position of the car mover in the hoistway;
a velocity of the car mover;
an acceleration of the car mover;
vibrations and impulses experienced by the car mover; and
a load of the car mover.

6. The car mover of claim 2, wherein:
the car mover controller is configured to execute the vehicle control module upon determining that the SOC of the power supply is:
below a first stored power range to execute proactive power management of the power supply; and
within a second stored power range to execute reactive power management of the power supply.

7. The car mover of claim 1, wherein:
when executing the health monitor protocols, the supervisory controller is configured to execute a supervisory control module, to thereby execute a plurality of levels of supervisory control in response to determining that the power supply is in a low SOC, including:
a first level of supervisory control, including adjusting dispatching requirements of the elevator car operationally connected to the car mover.

8. The car mover of claim 7, wherein:
a second level of supervisory control includes directing the car mover to a charging station.

9. The car mover of claim 7, wherein:
when executing the vehicle control module, the supervisory controller is configured to monitor the SOC of the power supply, and one or more of:
a position of other car movers within the hoistway;
requested floors to serve; and
a location of charging stations in the hoistway.

10. The car mover of claim 7, wherein:
the supervisory controller is configured to execute the supervisory control module upon determining that the SOC of the power supply is:
within a first stored power range to execute proactive power management of the power supply; and
above a second stored power range to execute reactive power management of the power supply.

11. A method of operating a car mover, configured to move an elevator car in lane of a hoistway, comprising:
powering, with a power supply, one or more motors, to drive a respective one or more wheels of the car mover,
wherein a car mover controller is operationally connected to the power supply and a supervisory controller operationally connected to the car mover controller;
executing health monitor protocols by the car mover controller and the supervisory controller, including:
monitoring a state of charge (SOC) of the power supply; and
controlling the car mover in response to determining that the power supply is in a low SOC.

12. The method of claim 11, comprising:
executing a vehicle control module, by the car mover controller when executing the health monitor protocols, thereby executing a plurality of levels of vehicle control in response to determining that the power supply is in a low SOC, including:
executing a first level of vehicle control, including adjusting one or more motion control parameters of the car mover.

13. The method of claim 12, wherein:
the one or more motion control parameters of the car mover includes velocity, acceleration, of the car mover, and vibrations and impulses experienced by the car mover.

14. The method of claim 12, comprising:
executing a second level of vehicle control, including directing the car mover to park at a nearest floor.

15. The method of claim 14, comprising:
monitoring, by the car mover controller when executing the vehicle control module, the SOC of the power supply and one or more of:
a position of the car mover in the hoistway;
a velocity of the car mover;
an acceleration of the car mover;
vibrations and impulses experienced by the car mover; and
a load of the car mover.

16. The method of claim 12, comprising:
executing the vehicle control module by the car mover controller upon determining that the SOC of the power supply is:
below a first stored power range to execute proactive power management of the power supply; and
within a second stored power range to execute reactive power management of the power supply.

17. The method of claim 11, comprising:
executing a supervisory control module by the supervisory controller when executing the health monitor protocols, thereby executing a plurality of levels of supervisory control in response to determining that the power supply is in a low SOC, including:
executing a first level of supervisory control, including adjusting dispatching requirements of the elevator car operationally connected to the car mover.

18. The method of claim 17, wherein:
executing a second level of supervisory control, including directing the car mover to a charging station.

19. The method of claim 17, comprising:
monitoring, by the supervisory controller when executing the vehicle control module, the SOC of the power supply, and one or more of:
a position of other car movers within the hoistway;
requested floors to serve; and
a location of charging stations in the hoistway.

20. The method of claim 17, comprising:
executing the supervisory control module by the supervisory controller upon determining that the SOC of the power supply is:
within a first stored power range to execute proactive power management of the power supply; and
above a second stored power range to execute reactive power management of the power supply.
